(19) United States
(12) Patent Application Publication
(10) Pub. No.: US 2006/0161482 A1
(43) Pub. Date: Jul. 20, 2006

(54) Method and system for aggregating real estate information content in an on-line computing environment

(75) Inventors: Jeffrey Jacobson, Potomac, MD (US); Ronald Segal, New York, NY (US)

Correspondence Address: KING & SPALDING LLP, 1180 PEACHTREE STREET, ATLANTA, GA, 30309, US

(73) Assignee: General Electric Capital Corporation, Stamford, CT (US)

(21) Appl. No.: 11/287,621

(22) Filed: Nov. 28, 2005

Related U.S. Application Data
(63) Continuation of application No. 09/766,760, filed on Jan. 22, 2001, now abandoned.
(60) Provisional application No. 60/252,016, filed on Nov. 20, 2000.

(51) Int. Cl. G06Q 30/00

(52) U.S. Cl. 705/26

(57) ABSTRACT

An on-line real estate information aggregation system for supporting real estate transactions by aggregating real estate-related information into a central research center. The research center tool enables users to conduct research on specific properties, markets, submarkets or property types within a market, to research and verify the credit worthiness of potential tenants, and to search commercial real estate news articles from an aggregated database. The on-line real estate information aggregation system comprises a distributed computer network, a plurality of client computers coupled to the distributed computer network, and a property services server platform connected to a data source. Hosted on the property services server platform are a real estate information processing tool for processing financial information, a research market module for accessing research information on available properties and markets, a credit reports module for accessing credit report information of individuals and companies, a news and analysis module for accessing real estate news information, and an order available reports module hosted on said property services server platform for enabling the purchase of market reports.

### FIELD OF THE INVENTION

The present invention is generally directed to the aggregation of information content providers and, more particularly, to the aggregation of real estate-related information content providers into a central research center to support real estate transactions in a distributed on-line computing environment.

### BACKGROUND OF THE INVENTION

Commercial real estate transactions are completed today with the support of “off-line” personal relationships among commercial real estate brokerage firms, property owners, and tenants. First, a commercial real estate broker attempts to identify and match the property space requirements of a potential tenant with the represented property owner. To “broker” a lease, the broker typically completes computer-aided and manual searches of market listings and property listings to locate potential matching properties. The broker may also wish to review various commercial real estate news articles for information on specific properties, markets, or submarkets that may be of interest to the potential tenant.

Even after the broker is successful in identifying and matching a property with a potential tenant, the transaction is far from complete. Before the transaction can be completed, the broker will often engage the services a number of business services, such as appraisers, engineers, surveyors, and others. In addition, the credit worthiness of the potential tenant must be researched and verified before the transaction can be completed. Each of these “off-line” steps require a tremendous amount of time and effort on the part of the broker and others. This results in an inefficient allocation of resources to complete a real estate transaction.

Thus, the commercial real estate services industry is highly inefficient in terms of cycle times and transaction costs. Transaction costs are high because these processes are people-intensive, involve multiple parties, and require participants to work on many more deals than they actually close.

Furthermore, indirect costs can also be significant. Access to market information and new deals is restricted to the “insiders' game” played by brokers. For example, a buyer may not receive an opportunity to bid on a building, the broker representing a tenant may have conflicts of interest if his or her fees rise with the rent agreed, or an owner may not be able to find the best source of capital.

Consequently, there is a need in the art for an on-line solution that improves the effectiveness and efficiency of commercial real estate professionals in executing their leasing, financing, and buy-sell deals. Furthermore, there is a need for a Internet-based platform that enables real estate professionals and participants to share information and documents needed in a typical real estate transaction.

### SUMMARY OF THE INVENTION

Generally described, the present invention provides an on-line tool for supporting real estate transactions by aggregating real estate-related information into a central research center. The research center tool enables users to conduct research on specific properties, markets, submarkets or property types within a market, to research and verify the credit worthiness of potential tenants, and to search commercial real estate news articles from an aggregated database.

More particularly described, the on-line research center tool can be used by prospective real estate buyers and sellers to research, evaluate and underwrite real estate markets, submarkets, and properties. Property managers can use the tool to review news stories for newsworthy information related to an owners' existing investments. Real estate brokers can use the search function of the research center tool to support existing and proposed transactions (e.g., research, evaluate and underwrite real estate markets, submarkets and properties) and to conduct credit analyses on potential buyers or tenants. The tool can also be used by lenders to obtain a package of economic, demographic and market data for “pre-underwriting” along with a loan application.

According to one embodiment of the present invention, users can interact with the research center tool in any of five different modules: Research Market, Credit Reports, News and Analysis, Order Available Reports, and Quick Feature Overview. Users can access any of these pages by clicking on a Research link on the top navigation bar or any other place on the site where the Research link is active.

According to another aspect of the invention, an on-line real estate information aggregation method and system is provided. The on-line real estate information aggregation system comprises a distributed computer network, a plurality of client computers coupled to the distributed computer network, and a property services server platform connected to a data source. Hosted on the property services server platform are a research market module for accessing research information on available properties and markets, a credit reports module for accessing credit report information of individuals and companies, a news and analysis module for accessing real estate news information, and an order available reports module hosted on said property services server platform for enabling the purchase of market reports.

According to another aspect of the invention, the research market module is operative to receive from a client computer search criteria for a desired property or market and compare the received search criteria with the research information stored in the data source. If the received search criteria matches the available research information, the system provides the research information to the user.

Similarly, the news and analysis module is operative to receive from a client computer search criteria for a desired category of news and compare the search criteria with the real estate news information stored in the data source. If the received search criteria matches the stored real estate news information, the system provides the real estate news information to the user.

These and other advantages and benefits of the present invention may be ascertained from the detailed description of the invention presented below and the drawings discussed therein.

### BRIEF DESCRIPTION OF THE DRAWINGS

FIG. 1 is a block diagram illustrating a representative-operating environment for an exemplary embodiment of the present invention.

FIG. 2 is a block diagram illustrating the primary components of a real estate services server platform for an exemplary embodiment of the present invention.

FIGS. 3a-g, collectively described as FIG. 3, are functional process maps illustrating the process for accessing the various components of the online research center tool constructed in accordance with an exemplary embodiment of the present invention.

FIGS. 4a-4i are representative display screens for a Web site supporting the online research center tool in accordance with an exemplary embodiment of the present invention.

### DETAILED DESCRIPTION OF THE EXEMPLARY EMBODIMENTS

A. On-Line Real Estate Services Environment

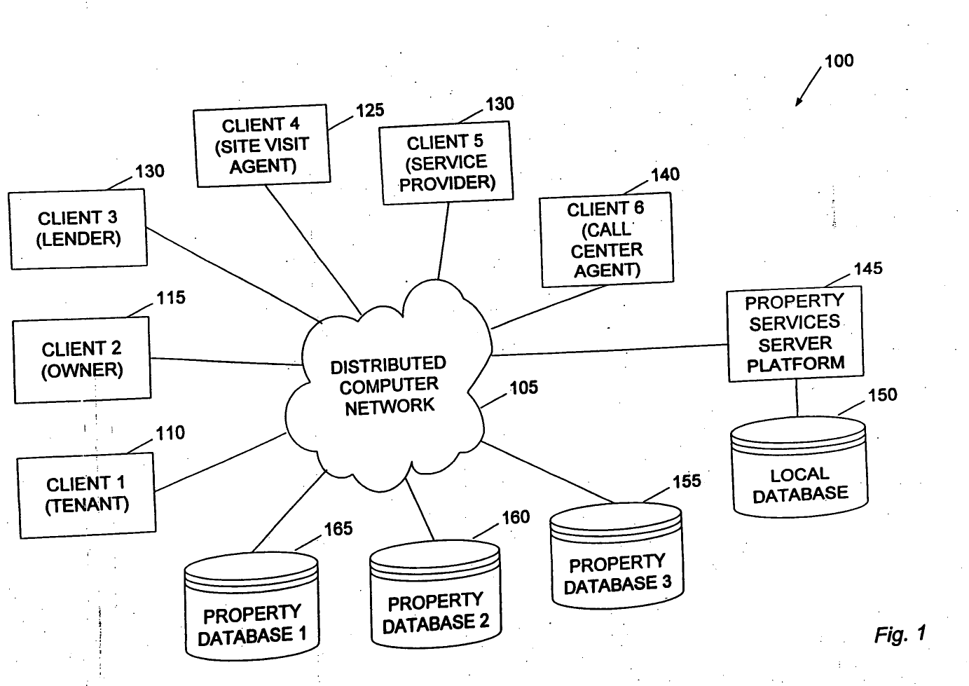

Turning now to the figures, in which like reference numbers are assigned to like elements, FIG. 1 is a block diagram illustrating the primary components of a representative operating environment for an exemplary embodiment of the present invention. An on-line property management environment 100 comprises a distributed computer network 105, such as the global Internet, coupled to numerous clients 110-140, a property services server platform 145 connected to a local data base 150, and numerous property information databases 155-165. For the client-server computing environment shown in FIG. 1, the client computers 110-115 represent typical users of property services hosted by the property services server platform 145. The client computers 120-140 represent service providers for servicing the activities of users in the property management field. For example, typical consumers of the property services accessible at the property services server platform 145 via the distributor computer network 105 include property tenants and property owners, as shown at the client computers 110 and 115. Representative service providers in the property management field include lenders, site visit agents, engineering, appraisal and environmental specialists, deal agents, and call center agents, as shown in connection with client computers 120-140.

The property services server platform 145 provides real estate industry services, including content, decision support tools, transaction exchanges, and access to key members of the real estate community and its service providers. For example, the property services server platform 145 can provide users operating client computers with convenient access to budgeting, forecasting, and valuation tools in the real estate field. The property services server platform 145 also enables a user, such as a tenant at the client 110 or a property owner at the client 115, to communicate via electronic mail with a lender at the client 120; a site visit agent at the client 125; a property specialist operating at the client 130; a deal agent operating at the client 135; or a call center agent operating at the client 140. The property services server platform 145 also can publish information at one or more Web site pages to facilitate the matching of a user, such as a tenant or owner, to a service provider. Although the matching of a user to a desired party can be facilitated by the on-line environment shown in FIG. 1, it will be appreciated that communications between these parties can be further accomplished by a variety of conventional means, including telephone, electronic mail messages, facsimile correspondence, mail delivery, etc.

The electronic communications framework of the on-line operating environment 100 enables a user, such as a tenant or owner, to efficiently identify and communicate with a variety of parties associated with the typical evaluation and closing of a real estate transaction. A lender, represented by the client 120, can work with a property owner or tenant to support financing requirements in connection with a real estate transaction. A site visit agent, represented by the client 125, can support a tenant's on-site review and analysis of a property under consideration. A provider specialist, represented by the client 130, can provide property-related expertise, such as engineering, appraisal, or environmental services, to a user in connection with a real estate transaction. A deal agent, represented by the client 135, can assist a user by screening, negotiating, and closing real estate-related transactions on behalf of that user.

Site Visit Agent

A user can select a site visit agent from information published at the property services server platform 145. The user communicates with the selected site visit agent, represented by the client 125, via the on-line environment 100 or by other conventional means. A site visit agent, typically based in a location proximate to the property or space of interest, can support a purchase or lease decision by showing the property or space to the parties of a transaction, such as tenants, owners, and lenders. For example, a site visit agent can visit a building or space of interest with an owner or purchaser and offer her expertise about the visit site, including configuration alternatives, build-out costs, etc. In contrast to a real estate broker, who often juggles several real estate transaction tasks at once, a site visit agent is focused solely on showing properties on behalf of her customer.

Property Specialist

The property services server platform 145 also provides a convenient on-line forum for connecting a variety of property specialists to the potential users of those services. For example, a tenant operating the client 110 can obtain information from the property services server platform 145 about the services offered by property specialists represented by the client 130, including appraisal, engineering, and environmental services. This information can include the identity of property specialists within a specified profession, such as engineering, appraisal or environmental services; contact information for property specialists in the selected field; and fee estimates for services provided by the listed property specialists. Consequently, the real property services service platform 145 provides a marketplace that enables a user to identify and to select a desired service provider within the framework of the on-line environment 100.

For example, a customer operating from a client site, such as a tenant client 110 or an owner client 115, can gain access to a service provider based upon the user's issuance of a request to the property services server platform 145. In turn, the property services server platform 145 can respond to this request by presenting information sufficient to facilitate a communication between the parties. For example, this communication link can be established by the server platform 145 via a hyperlink to a service provider's web site, electronic mail to a service provider, or publication of service provider contact information.

Deal Agent

A deal agent, represented by the client 135, can work on behalf of a user to support the completion of a property-related transaction, including leasing, financing, and buy-sell exchanges. The property services server platform 145 provides an on-line forum listing deal agents available to support a user's real estate transaction. In the absence of a relationship with another service provider, the user can rely upon the real estate expertise of a deal agent in evaluating and completing a property transaction. A user operating a client site, such as the client 110 or 115, can obtain the services of a deal agent by issuing a request to the property services server platform 145 or by contacting a customer service agent at the client 140. For example, the property services server platform 145 can establish communications between the user and a deal agent via selection of a hyperlink to a deal agent's web's site, electronic mail to a deal agent, or publication of contact information for a deal agent. The user also can contact a customer service agent based upon contact information published at the property services server platform 145.

Call Center Agent

A call center agent can handle a variety of contacts by customers of the property services, including requests for products and services; billing inquiries; Web-site assistance; and property services-related questions. A call center agent, typically located at a central call center site, can facilitate the scheduling of support by a site visit agent, a property specialist, or a deal agent, by responding to the schedules of the agent and the customer. In this manner, a call center agents operating at the client 140 can provide basic customer service via electronic communications, such as e-mail, by telephone, or other conventional communication means.

It will be appreciated that the call center functions are preferably delegated to personnel with a variety of call center and real estate experiences. For example, customer service agents with limited real estate experience can provide basic customer services, whereas deal agents with more substantial real estate experience can support the detailed aspects of leasing, financing, and buy-sell deals. Call center agents and deal agents can be housed in a central location to provide support to a variety of geographically dispersed users connected to the distributed computer network 105 via client computers.

Communications between lenders, site visit agents, deal agents, property specialists, call center agents and the customer are supported by electronic communications carried by the distributed computer network 105 or other conventional communication means. Although only a single call center client 140 is shown in FIG. 1, it will be appreciated that the on-line environment 100 can include multiple client computers supporting customer and deal services provided by customer service agents and deal agents.

Local and Remote Databases

Although the property services server platform 145 can access content and related property data from a local database 150, it will be appreciated that the distributed nature of the computing environment shown in FIG. 1 also supports retrieval of such information from remote data sources, such as the properly databases 155, 160 and 165. The distributed nature of the computer network 105 in the on-line environment 100 facilitates a user accessing information relevant to a real estate transaction in databases maintained at remote geographical sites. Significantly, users are no longer constrained from reaching a decision about a real estate transaction based only upon locally available information, such as the property information maintained at the user's desktop computer. The property services server platform 145 provides a central forum for a user's retrieval of real estate-related information from a variety of on-line services.

Property Services Server Platform

The property services server platform 145 can support an ASP model by delivering software applications or tools to users operating various clients, such as the tenant client 110, the owner client 115 or the lender client 120. This ASP model allows a client running a Web browser to connect via the distributed computer network 105 to the property services server platform 145 and to access a variety of real estate-related applications and to manipulate and store real estate data. Typical applications operated by the property services server platform 145 include budgeting, financing, forecasting, and valuation tools for the real estate industry.

Focusing on the valuation application, this tool allows the customer at a client-computing site to value a real estate asset by inputting information about the asset's actual and projected revenues and expenses. In addition, the user can access objective benchmark data, such as property comparables, maintained at the local database 150 or databases maintained by third parties, such as the property databases 155, 160 and 165. A user can use the valuation tool within the ASP model to assess the relative value of a building, to model alternative scenarios, and to address due diligence issues based upon a variety of assumptions. The output of the valuation process can be formatted in a standard electronic format for transmission to other clients coupled to the distributed computer network 105, such as the lender client 120, to facilitate a real estate transaction.

Other applications available at the ASP model hosted by the property services server platform 145 include payback calculation tools, cash flow calculation tools and space calculation tools. The payback calculation tools can include a lease improvement calculator, a direct capitalization calculator and a refinancing calculator. A user can operate the lease improvement calculator to calculate how much of standard rent will go towards building standard improvements and how much profit is available from such standard improvements. The direct capitalization calculator allows a user to calculate a capitalization rate. The refinancing calculator allows a user to calculate refinance loan savings and breakeven terms.

The cash flow calculation tools include a mortgage and amortization calculator and an affordability calculator. A user can operate the mortgage and amortization calculator to calculate mortgage payments on a fixed or a variable commercial loan and to calculate principal and interest payments over the term of a fixed loan. The affordability calculator allows a user to calculate the loan amount based on net operating income (NOI) and basic underwriting criteria.

The property services server platform 145 also operates as a Portal by providing a central Web site for a consumer's real estate-related operations. For Portal operations, the property services server platform 145 aggregates a variety of real estate-related tools and services at a single Web site accessible by consumers, service providers and agents via client computers. For example, the property services server platform 145 can offer consumers the opportunity to use a single Web site to conveniently complete due diligence activities for a real estate transaction, to analyze market aspects of the transaction, to finance the transaction and to access service providers in support of the transaction. A consumer operating a browser at a client site, such as the client 110 or 115, can create a “personalizable” workspace for her real estate-related transactions at the property services server platform 145. This server platform also provides a central location in an on-line computing environment for reviewing a consumer's real estate activities, current real estate news and research, and relevant property and stock market information. Typical portal operations include the personalizable workspace, described as “My Workspace,” a variety of services, including research, financing, leasing, and calculation tools, and access to real estate experts.

For example, the property services server platform 145 supports the delivery of a variety of services to a client via the distributed computer network 105, including research, financing, leasing, and other business services. A user operating from a client-computing site, such as the owner client 115, can research a specified property topic by requesting results from the property services server platform 145. The property services server platform 145 can respond to this research request by obtaining relevant research information from either the local database 150 or one or more of the property databases 155, 160 or 165. Typical research includes commercial real estate news, typically sorted by property-type, market, or company name, market indices, interest rates, stock prices, and market demographics.

For financing services, property owner can use a client computer, such as the client 115 to request a financing quote from the property services server platform 145. In response to loan parameters specified by the owner, the property services server platform 145 can complete an on-line financing application and forward the completed application to one or more lenders at the client 120. The lender can process the electronic data set associated with the completed financing application and transmit a financing quote to the owner via the distributed computer network 105. For an exemplary embodiment, the completed financing application prepared by the property services server platform 145 can include in electronic format the loan request, property-related research, property valuation, and other information selected by the user.

The property services server platform 145 also can support the negotiation and execution of the real estate transaction in an on-line environment. For example, a tenant operating at the client 110 and a property owner operating at the client 115 can evaluate the parameters of a real estate transaction by using the tools and research available at the property services server platform 145. In an on-line exchange hosted by the property services server platform 145, the tenant at the client 110 can post a bid and, in response, the property owner at the client 115 can post a reply. A deal agent at the client 135 can work with the tenant at the client 115 via the distributed computer network 105 to support transaction negotiations. Upon completion of on-line negotiations, the transaction can be formalized by populating an on-line agreement with the negotiation terms. It will be appreciated that this on-line transaction environment operates to reduce the transaction costs associated with a conventional real estate transaction.

In view of the foregoing, it will be appreciated that the on-line environment 100 supports the effectiveness and efficiency of commercial real estate professionals in the execution of leasing, financing, and buy-sell transactions. This on-line environment 100 can fulfill the needs of its users by supporting efficient communication of information via a distributed computer network among a community comprising tenants, owners, lenders, site visit agents, cost center agents, and a variety of service providers.

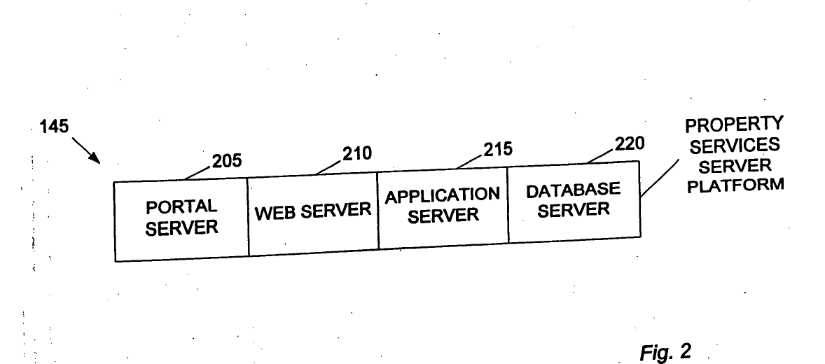

FIG. 2 is a diagram illustrating the primary components of the property services server platform 145. Turning now to FIG. 2, the property services server platform 145 comprises a portal server 205, a Web server 210, an application server 215 and a database server 220. As indicated by their descriptive names, the servers 205-220 support portal, Web, application and database functions of property services server platform 145. For the exemplary embodiment, the operating environment is implemented by Sun Microsystem's “SOLARIS” operating system. An “Epicentric” server implements the portal server 205. An “iplanet” server implements the Web server 210. A “WebLogic” server implements the application server 215, which supports the ASP model. The database server 220 is implemented by Oracle's “81” server and corresponding database. Although not illustrated in FIG. 2, it will be understood that the property services server platform 145 is protected by conventional firewalls, being SSL security protocol, physical security, and includes emergency back-up capabilities.

B. Research Center

Generally described, the present invention provides an on-line tool for supporting real estate transactions by aggregating real estate-related information into a central research center. The research center tool enables users to conduct research on specific properties, markets, submarkets or property types within a market, to research and verify the credit worthiness of potential tenants, and to search commercial real estate news articles from an aggregated database.

More particularly described, the on-line research center tool can be used by prospective real estate buyers and sellers to research, evaluate and underwrite real estate markets, submarkets, and properties. Property managers can use the tool to review news stories for newsworthy information related to an owners' existing investments. Real estate brokers can use the search function of the research center tool to support existing and proposed transactions (e.g., research, evaluate and underwrite real estate markets, submarkets and properties) and to conduct credit analyses on potential buyers or tenants. The tool can also be used by lenders to obtain a package of economic, demographic and market data for “pre-underwriting” along with a loan application.

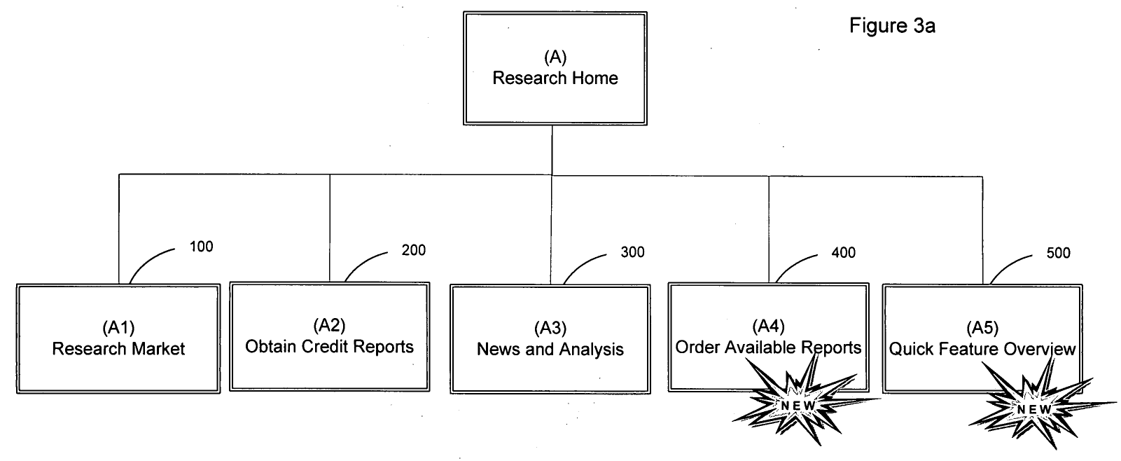

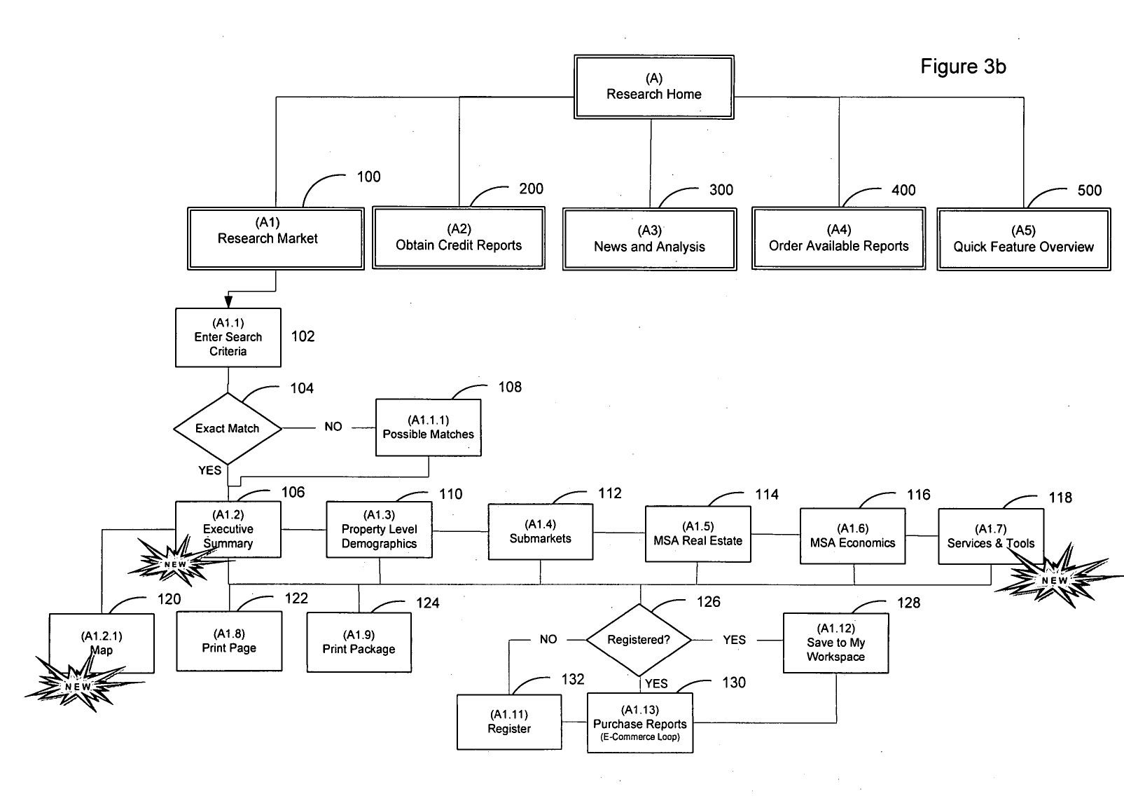

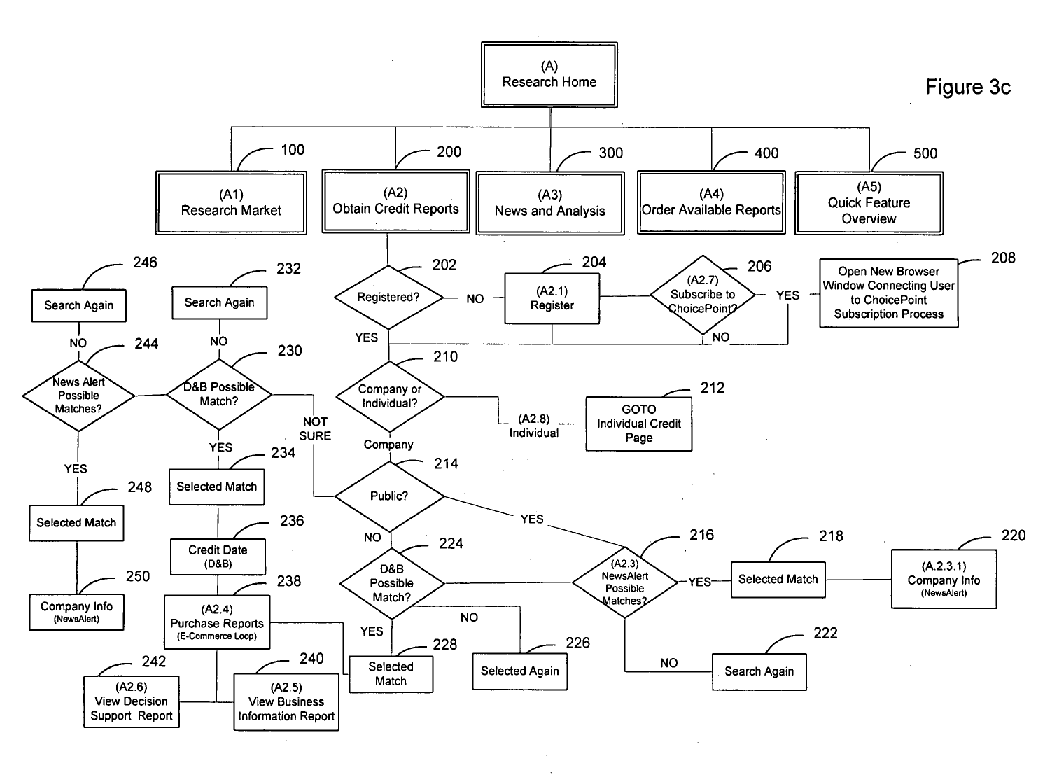

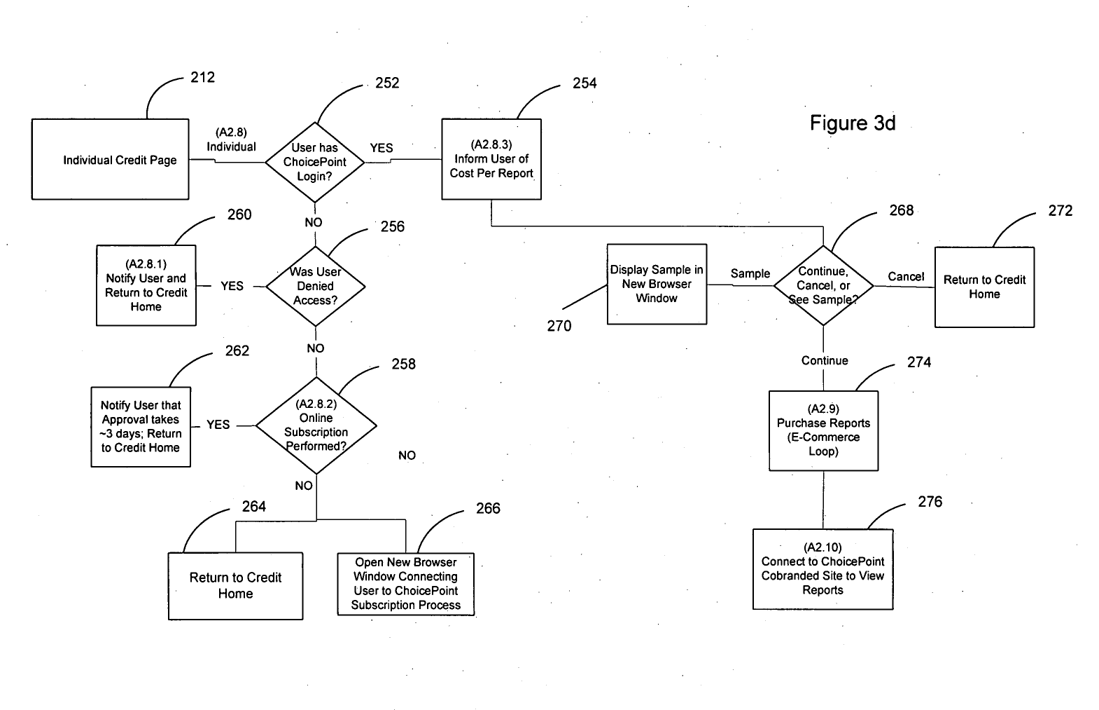

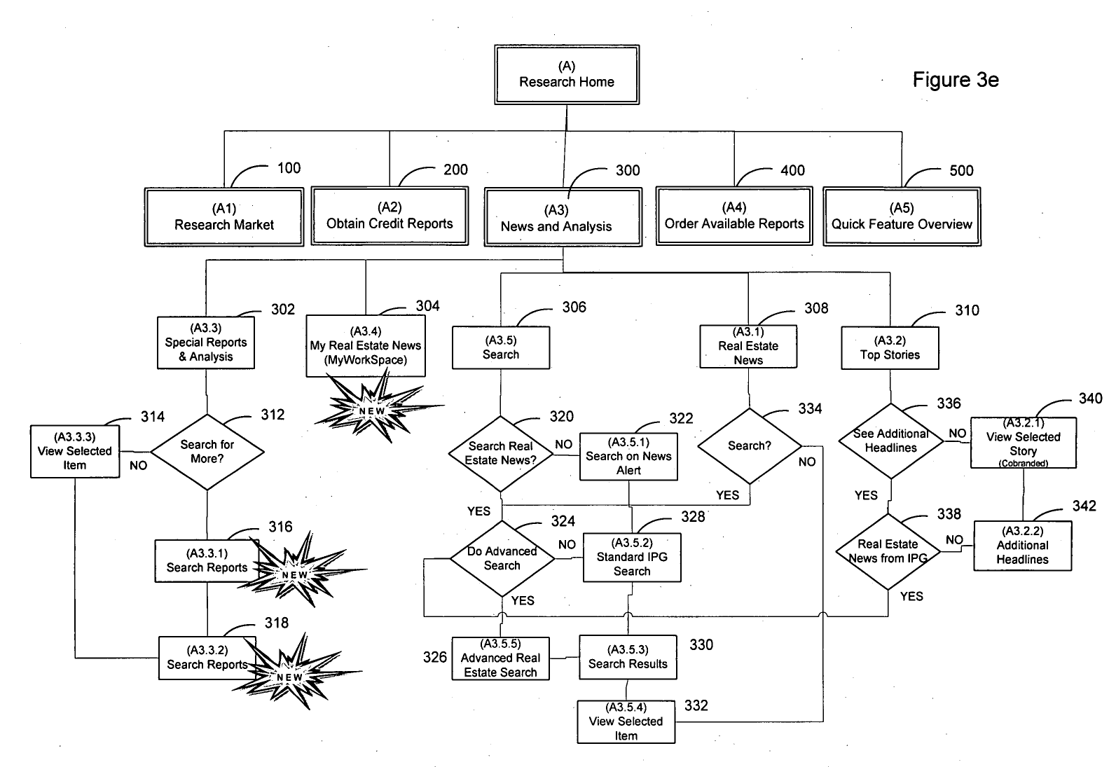

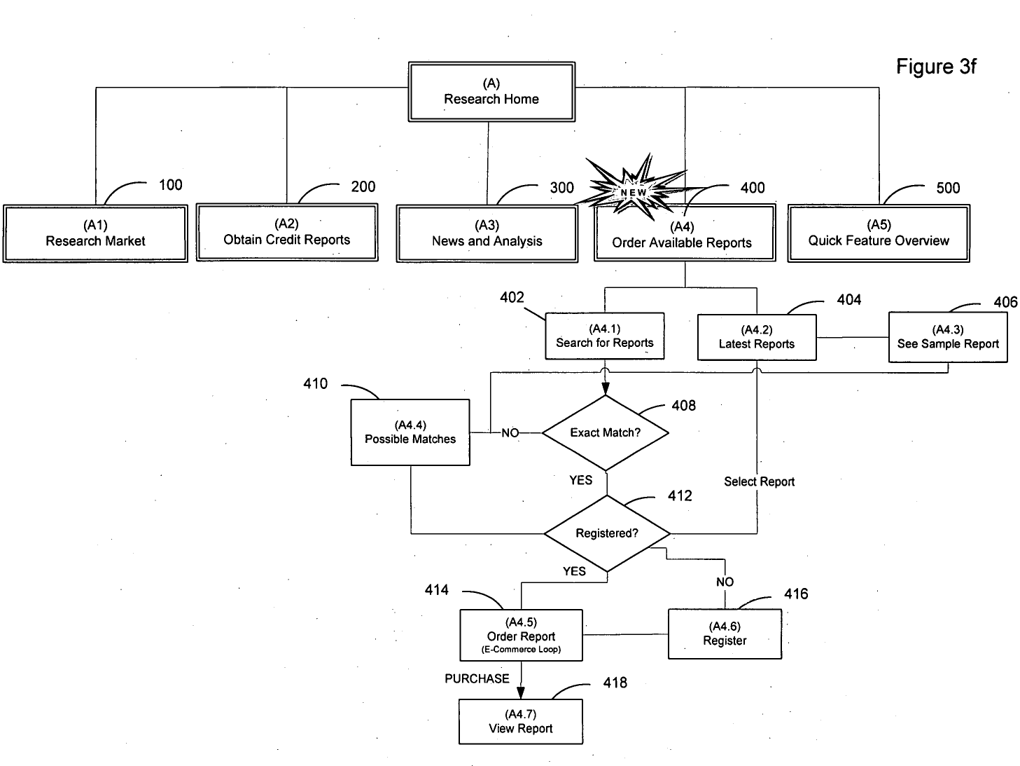

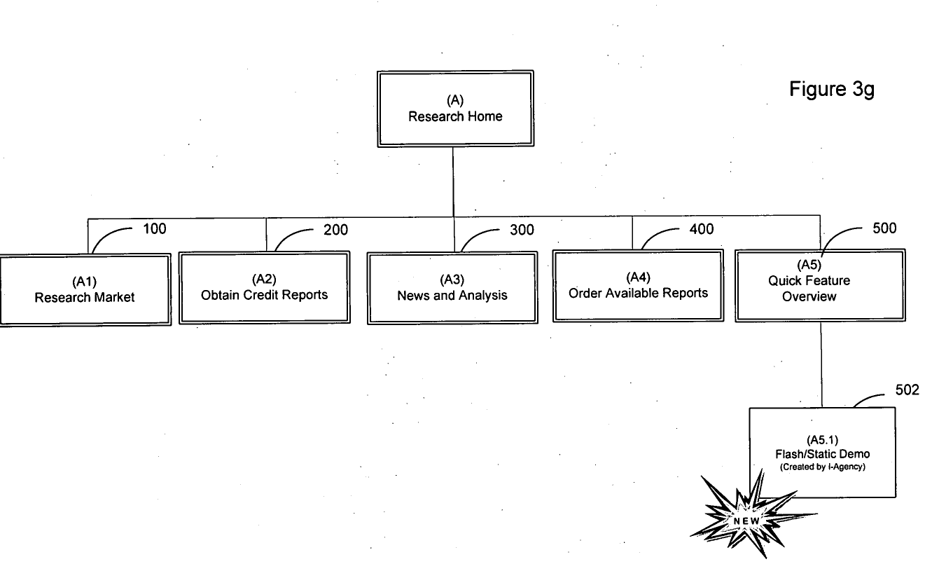

FIGS. 3a-g are functional process maps illustrating an exemplary functional process for accessing the various components of the research center tool. As shown in FIG. 3a, users can interact with the research center tool in any of five different sections: Research Market 100, Credit Reports 200, News and Analysis 300, Order Available Reports 400, and Quick Feature Overview 500. Users can access any of these pages by clicking on a Research link on the top navigation bar or any other place on the site where the Research link is active.

Referring specifically to FIG. 3b, the research tool allows users to search for a property address or market and review the available research information on that address or market. A user can access the search section by clicking on a Research Market navigation link in the research center tool.

To conduct a search, the user enters information into the following fields on the “Enter Search Criteria” form at step 102. The default “Enter Search Criteria” page includes the following fields:
Property Name
Address
City
State
Zip Code
Property Type

“Property Name” is a user-entered field for entering and assigning a short descriptive name to the property. Allowable names are any alphanumeric or extended ASCII character. This field is optional when the user is conducting a search unless the user wishes to save the results for future retrieval.

“Address” is a user-entered field for entering the street address to search for. Allowable values are any alphanumeric or extended ASCII character. The “Address” field is optional when conducting a general market search. This field is required if the user wishes to see property specific information, such as Property Demographics report or a GIS-generated Ring Study.

“City” is a user-entered field for entering the city to search for. Allowable values are any alphanumeric or extended ASCII character. This field is required and is visibly identified as such.

“State” is a user-selected field for entering the state for the system to search on. Values are obtained from a pull-down list maintained by the system. The default is a blank/empty string. This field is required and is visibly identified as such.

“Zip Code” is a user-entered field for entering the zip code for the system to search on. Allowable values are any integer from 0 to 9. Maximum field length is 9 characters. The system can search on any number of characters 3 or greater. This field is optional.

“Property Type” is a user-selected field for entering the property/collateral type to search for. For example, in an exemplary embodiment of the present invention, the property types include industrial, residential, office, retail, and other. Other property types may be included as well. Values are obtained from a pull-down list-maintained by the system. This field is required and is visibly identified as such.

At step 104, if an exact match is found for the property or MSA, the system will return that property's or MSA's information. On the other hand, if an exact match is not found, the system will present the user with a list of potential matches that meet the search parameters selected by the user (step 108). These potential matches will be retrieved as hyperlinks. The user may then select one hyperlink to view that property's information. Only one hyperlink may be selected at a time (no checkbox/multiple selection feature).

Once the system finds a match, the system will perform the following steps in sequential order:
Determines the latitude and longitude based on the address.
The GIS spatially places the latitude and longitude at the market, submarket and zip code level. The system will note the property type entered on the Property Search form and will display that property type only.
Dynamically creates a right navigation bar (tab) based on where the property is located.
If and only if the user is logged in as a GE Capital User, the GE Information tab will be displayed on the left navigation bar. This link will be a URL address that links to a page on the vendor's site. This URL will have the parameters (latitude, longitude, zip code, MSA code, MSA property type code, and submarket code appended to it.)
   Example URL:
      http:\\www.vendorsite.com?zip-20850&msacode=8840&msapropertyt ype=8840apt&submarket=961222&lat=34.11111&long=88.77777

The left navigation bar will be displayed in the following order:
Executive Summary 106
Property Level: Demographics 110
Submarket 112
MSA Real Estate (Market and Property Type) 114
MSA Economics 116
Services and Tools 118
GE Information (GE Capital Users Only) (not shown)

If a search-retrieves a property location that is not part of a recognized MSA (for example Pierre, S.D.), the property information will still be retrieved, but the MSA Real Estate (Market—Property Type) 114 and Submarket 112 navigation tabs will not be accessible. If the GIS system does not find a submarket for a property, it will still generate MSA Real Estate (Market—Property Type) 114 and Property Demographics 110 links on the left navigation bar, but will not generate the Submarket link 112.

When a page is surfaced, it only pulls the hyperlinks. Only when the user clicks on a link is that page generated dynamically. The system does not save static pages. If the user chooses “Other” as the property type, the system will generate pages as described above, however it will not return the MSA Real Estate page 114 or the Submarkets page 112.

In the case of MSA or submarket searches, once the system finds a match, the system will perform the following steps in sequential order:
Accesses the MSA and Submarket tables to find a match based on the search criteria.
Dynamically creates a left navigation bar based on where the property is located.
If and only if the user is logged in as a GE Capital User, the GE Information tab will be displayed on the left navigation bar. This link will be a URL address that links to a page on the vendor's site. This URL will have the parameters (msa code, msa property type code, and submarket code appended to it.)
   Example URL:
      http:\\www.vendorsite.com? msacode=8840&msapropertytype=8840apt&submarket=961222

The left navigation bar will be displayed in an order to be determined by the interactive agency:
Executive Summary 106
Property Level: Demographics 110
Submarket 112
MSA Real Estate (Market and Property Type) 114
MSA Economics 116
Services and Tools 118
GE Information (GE Capital Users Only) (not shown)

If the system does not find a submarket for a property, it will still generate the Market—Property Type and Market links 114 on the left navigation bar, but will not generate the Submarket link 112. When a page is surfaced, it only pulls the hyperlinks. Only when the user clicks on a link is that page generated dynamically. The system does not save static pages.

Research: Executive Summary (106)

The Executive Summary page 106 provides a quick one-page overview of key information from each of the component pages in a research package. The results from any Research Market Search will default to the Executive Summary page. The following sections will be retrieved on the Executive Summary page:

Map

MSA Economics

MSA Real Estate

Submarket

Property Level Demographics

Services and Tools

The sections generated in the Executive Summary will map exactly to the complete pages generated for the research package. Just as only the pages appropriate to a specific Research Market Search will appear in a research package, only those sections will be represented and displayed in the Executive Summary. For example, if a user enters a property without an address, neither a Property Demographics page nor a Property Demographics section within the Executive Summary will be generated. Users can view the full page of information by clicking on any of the tabs located on the right side of the screen.

Executive Summary—Map (120)

“Map” is a static thumbnail. When the user clicks on the Street Map thumbnail, an enlarged version of the Street Map will open in a separate pop-up window. The user may click on the Get Directions button to link to the vendor's website to obtain driving directions to the selected address. A separate browser window/instance will open with all browser navigation features disabled. The following Map Manipulation features will be available for all enlarged maps (functionality described in detail in Property Demographics section below):
Zoom
Scroll Map
Recenter Map
Labels
Legend

“MSA Economics” 116 provides a bullet description of economic trends in the metropolitan area, and includes the following components:
MSA Identification
Primary MSA Strength
Primary MSA Weakness

“MSA Real Estate” 114 provides a bullet description of the real estate trends in the property type for the market, and includes the following:
Market—Property Type Identification
Average Rent Ranking (quintile)
Average Vacancy Rate Ranking (quintile)
Inventory Grade Ranking (quintile)

“Submarket” 112 provides a bullet description of real estate trends in the submarket for the selected property type, and includes the following:
Submarket Identification
Vacancy Rate Ranking
Effective Rent per Square Foot

“Property Level Demographics” 110 provides a static bullet list of demographic information. The following information will appear:
Population
Housing Trends
Income Trends

“Services and Tools” 118 provides links to the various services and business tools the user can access for the property/market currently being displayed.

Research-Market—Property Level Demographics (110)

The following sections can be retrieved on the Property Level Demographics page 110:
Property Details
Maps
Select Radius
Demographic Trend
Population by Age
Crime Reports
Households By Income
Household Expenditures

The naming convention for this page is “Property Level: Demographics.” A section on the page includes a hyperlinked logo to the website of that data source vendor. Clicking on the logo will open a new browser window/instance that opens the sponsoring vendor's web page. By default, no browser navigation (Back/Forward buttons, etc.) or URL Address fields will be displayed on the new browser instance.

A. Property Details

“Property Details” is a quick reminder for the user of the property search criteria entered and currently being displayed on the page. The table identifies the following information:
Property Name
Address
City, State and Zip Code
Property Type
Metro Area
Property Market
Submarket

“Metro Area,” “Property Market” and “Submarket” are active hyperlinks to the detail pages related to the current property being displayed. The links map exactly to the hyperlinks displayed on the left navigation bar. Only those hyperlinks that are valid for that search will be displayed. If there is no related detail page for that search (for example, no submarket page), then that field will note that fact (Submarket: None). The field will not be a hyperlink in this instance.—

All-data and information on the Property Level Demographics page will default to a 3-mile radius from the property address. A pull-down table will 110 enable the user to select 1, 3 or 5 miles as the radius. Clicking on any of these links will cause the page to regenerate and automatically recalculate the numerical fields based on the new radius.

B. Maps

“Maps” provide two interactive maps that enable the user to visually locate the property address and view demographic information associated with that address. The system will provide a Ring Studies map and a Street Map in one module on the page. Each map will be initially displayed as a distinct thumbnail. The exact map functionality will be determined by the MAPINFO contract. The desired functionality is described below.

The Ring Studies map is a static thumbnail. When the user clicks on the Ring Studies thumbnail, an enlarged version of the Ring Studies map will open in a separate pop-up window. The functionality of the Ring studies map is specified by the Mapinfo contract. The user may change his or her map selection by clicking on the appropriate hyperlink.

A Street Map will also be provided as a static thumbnail. When the user clicks on the Street Map thumbnail, an enlarged version of the Street Map will open in a separate pop-up window. The following Map Manipulation features will be available for all enlarged maps:
Zoom
Scroll Map
Recenter Map
Labels
Legend

Zoom will allow the user to zoom in or out of the enlarged map images as desired. The map's default zoom level depends on whether the user selected a Property or Market Search. Property Search maps will default to display at sufficient detail to view the selected property address and surrounding area. Market Search maps will default to display Submarket information.

The map will clearly display the current zoom level at all times. A radio button scale, slide bar or some other graphic device will enable the user to select and change zoom levels directly in the map's pop-up window. The system will also allow the user to enter the “+” button on the keyboard to zoom in and view greater map detail, and the “−” button on the keyboard to zoom out and display less map detail. Whenever the user selects a new zoom level, the system will immediately regenerate the map to provide the newly selected level of detail.

Scroll Map allows users to scroll enlarged maps to view map details that are at the edges of the current map or off the map entirely. The system will allow the user to move the map's center up, down, left or right.

A radio button scale, slide bar or other graphic device will enable the user to move the map's center directly in the map's pop-up window. The system will allow the user to scroll the map in the pop-up window by holding the left mouse button down and moving the mouse/pointing device in the desired direction. The system will also allow the user to press the Up Arrow button on the keyboard to scroll up on the map, the Down Arrow scroll down, the Left Arrow to scroll to the left and the Right Arrow to scroll right. Whenever the user scrolls the map, the system will immediately regenerate the map at the current zoom level and move it as selected.

Recenter Map allows users to recenter the enlarged map at any time and return the map center to its initial session location. A single button or link will provide the user with a quick method for recentering the map on the original property address or submarket that the user entered. The system will also allow the user to press the “=” button on the keyboard to recenter the map. Whenever the user recenters the map, the system will immediately recenter and regenerate the map at the current zoom level.

Labels will help the user locate the selected property address or submarket on the enlarged map by identifying geographical and roadway features in close proximity to the selected search location. The selected property address should be visibly identified using a star, push pin or other such graphic element. This particular graphic element will be unique on the map and no other landmark will use it. Labels are provided for the following map elements: U.S. interstates, state highways, primary roads, railroad tracks, bodies of water, and recognized and identifiable buildings.

Legend will be included on all maps to provide a visual key to the meaning of the information being displayed. Each map will use a single (different) color at different shading variations to depict the appropriate information for that selected option. Shading variations are to be used to ensure the maps are readable by people who may be color-blind. Heavier shaded regions will indicate a higher numerical value or score, lighter shaded regions indicate a lower numerical value/score. Legends will be displayed in a consistent location on the right side of all pop-up maps. The numerical value of each color and/or shading will be clearly indicated in the legend and will include the units appropriate to that map.

C. Select Radius

Select Radius is a pull-down that allows users to select the radius around the selected property address (as defined during the initial Research Market Search process) that is located and identified at the map center. When the user changes the radius selection, the system will automatically recalculate and regenerate the numerical information in all tables and graphs on the page to reflect the new radius.

D. Demographic Trend

“Demographic Trend” presents teaser data about households within the selected radius. In an exemplary embodiment of the present invention, the table displays the following teaser demographic data returned from the GIS system for the 1990 census, Current Year Update, 5 Year Projection:
Population
Households
Families
Median Age
Average Household Size

Users can view the summary data on this page or purchase various full reports for additional fees. The user will enter purchase information directly on the web site. Payments for report purchases will be processed and collected on the web site. The Demographic data and reports will be hosted on the web site. Reports will be predefined in format but generated dynamically based on the selected properties latitude and longitude. Reports may load in html format or in other formats. The system will audit report purchases.

A “See Report Sample” button is provided in the left navigation area of the page. Users can click on this button to view a sample report prior to purchasing a real one (A.13).

A “Purchase Report” button 130 is provided at the bottom of the left navigation area of the page. Users can click on this button to purchase the full Demographics Report.

E. Population By Age

“Population by Age” presents teaser data about population age data within the selected radius. The table displays teaser population data returned from the GIS vendor for different time periods. Age data is broken out in the following manner:
Less than 18
18-34
35-50
51-65
Over 65

The population by age data displays 4 distinct columns of data:
Current Year Update
Current Year % of Total Population
Current Year US % of Total US Population
Area Index=Current Year %/Total US %

F. Crime Reports

“Crime Reports” presents teaser data about reported crime rates within the selected radius. The table displays teaser crime data returned from the GIS vendor for different time periods. The GIS vendor obtains this information from a third-party source and collates it with other GIS-supplied information. The data is a set of indexes established by the third party vendor and is compared to the US index. The following indexes or close replicas will be provided:
Crime Risk Index
Personal Crime Index
Property Crime Index

Users can view the summary data on this page or purchase a full report for an additional fee as described above.

G. Households by Income

“Households by Income” presents teaser data about income levels within the selected radius.
The table displays teaser income data returned from the GIS vendor for different time periods. The GIS vendor obtains this information from a third-party source and collates it with other GIS-supplied information.
The household by income data displays 4 distinct columns of data:
   Current Year Update
   Current Year % of Total Households
   Current Year US % of Total US Households
   Area Index=Current Year %/Total US HH %
Households by Income is broken into the following groups to be displayed in the table:
   Income <$25K
   Income $25-$50K
   Income $50-$100K
   Income $100K+
   Median HH Income (Only Column 1 and 3)
   Average HH Income (Only Column 1 and 3)
Users can view the summary data on this page or purchase a full report for an additional fee as described above.

H. Household Expenditures

“Household Expenditures” presents teaser data about household expenditures within the selected radius. The table displays teaser data returned from the GIS vendor for different time periods. Household Expenditure Data will be broken out in the following manner:
Total Expenditures
Total Non Retail Expenditures
Total Retail Expenditures

The Household Expenditure Data will display 3 distinct columns of data:
1990 Census Values
Current Year Update
5 Year Projected Value
   Research Market—Submarkets (112)

The following sections will be retrieved on the Submarket page when it is generated:
Real Estate Fundamentals and Map
Street Map
Demographics
Zip Codes
Current Real Estate News
Services

Each section on the page will include a hyperlinked logo to the website of that data source vendor. Clicking on the logo will open a new browser window/instance that opens the sponsoring vendor's web page. By default, no browser navigation (Back/Forward buttons, etc.) or URL Address fields will be displayed on the new browser instance.

A. Real Estate Fundamentals and Map

Real Estate Fundamentals and Map provides a graphical map and tabular representation of the real estate industry for the selected submarket and property type. The vendor will provide raw numerical data displaying the following data for each submarket within the market property type:
Current Submarkets Statistics-1Q 2000
   Submarket Name
   Building Rank
   Inventory Rank
   Rent Standing
   Vacancy Standing
Top Performing Submarkets—Rent Growth, Inventory growth, vacancy (Only top 3 rankings)
   Submarket Name
   Rent Growth rank
   Inventory Growth Rank
   Vacancy Rank
   Composite Rank
Top Performing Submarkets—Construction (Only top 2 submarkets)
   Submarket Name
   Total Projects
   Percent of Metro
   Total SF
   Percent of Metro

The data source vendor will provide a look-up table with the submarkets defined for each MSA. The system will store the table on-site. This table will be updated on an ad-hoc basis, as necessary. The vendor will also provide boundary file to be mapped. The specifications (file type, resolution, size, etc.) for these maps will be determined at a later date. When the user clicks on the Submarket thumbnail, an enlarged version of the map will open in a separate Java pop-up window. The submarkets within the MSA will be broken out and visually identified.

A map provided by the GIS vendor will dynamically create itself showing the selected submarket in one color and other submarkets in the market place in another color. Map will also show other major geographic features like highways, parks, zip codes, etc. as described in the Map bullet in the Property Demographics Page section above. Raw numerical data will be displayed sorted by building rank and by composite rank with the selected submarket specially indicated either by bolding or displaying in a unique color. Users can view the summary data or purchase one of several full reports for an additional fee. Users will be redirected to vendor site to purchase a full report Payments for report purchases will be processed and collected by vendor A See Samples button will be provided at the bottom of the Real Estate Fundamentals section. Users can click on this button to view a sample report prior to purchasing a real one (130).

An Order Report button will be provided at the bottom of the Real Estate Fundamentals section. Users can click on this button to purchase the Real Estate Fundamentals report for the Submarket—Property Type. The user will then access the Purchase Reports function as defined in the E-Commerce section of the Back-End Processing Requirements document. User will be redirected to vendor site to pull the report (130).

B. Street Map

Street Map provides an interactive street map that enables the user to visually locate properties in a Submarket. The street map will be initially displayed as a distinct thumbnail. A Street Map will also be provided as a static thumbnail. When the user clicks on the Street Map thumbnail, an enlarged version of the Street Map will open in a separate pop-up window. Enlarged maps will be interactive and allow for zooming in and out of their respective images as described in the Maps item in Property Demographics Page above. Enlarged maps will include legends as described in the Maps item in Property Demographics Page above.

C. Demographics

Demographics provides a link to an order entry page which allows the end user to purchase a set of full Demographic Reports for the selected Submarket. The report is obtained from a defined GIS report template that uses the currently selected search as its input. Clicking on the link will open the report in the current browser window.

D. Zip Codes

Zip Codes provide a listing of the Zip Codes within a Submarket area. The system will display the Zip Codes and their associated cities that reside within the selected Submarket area. Table fields for the zip-lookup table provided by the vendor include:
Zip Code
City
MSA-ID
County-ID
Submarket-ID

Due to vendor constraints, zip codes may not necessarily map exactly to the MSA or Submarket. Clicking on a Zip code will present a demographics report. The format of this report is determined by the Mapinfo contract. Clicking on the link will open the report in the current browser window.

E. Current Real Estate News

Current Real Estate News is a listing of real estate news related to the Market and Property Type that the user is currently viewing. The system will display the headlines of the last five real estate news articles from the vendor that are related to the MSA and Property Type the user is currently viewing.). If there are no articles for the MSA, the system will display that last 5 articles. The news articles headlines will be displayed as hyperlinks. Clicking on the hyperlink will display the real estate article in the current browser window.

A More button or similar navigational feature at the bottom of this module will allow the user to view additional article headlines. On the more page, there will be a keyword search box, a radio button (allowing the user to search in the currently selected category or among all stories) and a go button to search the archives. (Note: The articles are searchable from NewsRoom—see the NewsRoom section below.) Articles are archived and searchable based on the functional requirements documented in the NewsRoom section below.

F. Services

Services provide static links to outside business services that may be of interest to those in the real estate profession. The system will offer links to the following services:

Survey
Title
Permits
Construction

When the user clicks on a services link, a separate browser window/instance will open. The navigational features (Back/Forward buttons, etc.) and the URL address window will be disabled. The system will link to an outside search capability such as a yellow pages directory. The outside search fields will be populated through the URL or other such mechanism, and based upon on the Services link the user selected, as well as the geographical area (Submarket or grouping of zip codes) and Property Type the user is currently viewing.

Research Market—MSA Real Estate (114)

The following sections will be retrieved on the Market Property Type page when it is generated:
Real Estate Fundamentals
Metro (Market) Rankings
Construction Projects
Construction Cost Data (deleted as per Chris Dolan)
Demographics
Special Reports and Analysis
Current Real Estate News
Services
Submarkets

Each section on the page will include a hyperlinked logo to the website of that data source vendor. Clicking on the logo will open a new browser window/instance that opens the sponsoring vendor's web page. By default, no browser navigation (Back/forward buttons, etc.) or URL Address fields will be displayed on the new browser instance.

A. Real Estate Fundamentals

Real Estate Fundamentals provides a graphic and tabular representation of the real estate industry for the selected MSA and property type.
The vendor will provide numerical supply and demand data for the past 4 years and current year for graphing only (no tabular format to be shown).
The data source vendor will provide this numerical data on a monthly basis.
A static gif will display the data and present a supply/demand chart.
The system will provide the following columns of data for the selected market property type:
   Current Quarter
   USA Current Quarter
   % Diff US & Market
The system will receive the following data points for the columns above:
   Average Rent
   Rent Growth
   Average Vacancy
   Vacancy Growth
Construction/Absorption Ratio is a tabular display which compares MSA and US for the current quarter and previous year.
Users can view the summary data or purchase full reports for additional fees.
The user will enter purchase information directly on the vendors site. Payments for report purchases will be processed and collected on the vendors site.
A See Sample button will be provided at the bottom of the Real Estate Fundamentals section. Users can click on this button to view a sample report prior to purchasing a real one (A130).
An Order Report button will be provided at the bottom of the Real Estate Fundamentals section. Users can click on this button to purchase the Real Estate Fundamentals report for the Market—Property Type. Users will be redirected to vendor site to purchase full reports (A130).

B. Metro Rankings

Metro Rankings is a quick view ranking the current Market—Property Type against other markets in the United States.
The ranking information will be displayed in a simple table.
The table will have 3 rows (Inventory Rank, Rent Growth Rank and Vacancy Rank) and 2 columns (Rank in Top XX MSAs and Relative to U.S.)
The rankings are based on a field in the database that provides a count of MSAs for the selected property type.

C. Construction Projects

Construction Projects is a tabular display of the new construction projects within the selected Market—Property Type
The vendor will provide the Number of New Projects, Square Feet (or units in the case of the Multifamily property type) and Inventory Growth for the selected Property Type Market
The user will enter purchase information directly on the vendor's site. Payments for report purchases will be processed and collected on the vendors site.
A See Sample button will be provided at the bottom of the Construction Projects section. Users can click on this button to view a sample report prior to purchasing a real one.
An Order Report button will be provided at the bottom of the Construction Projects section. Users can click on this button to purchase the Construction Projects report for the Market—Property Type. Users will be redirected to vendor site to purchase full reports (130).
The vendor will provide the data on a monthly basis

D. Demographics

Demographics provide a link to a full Demographic Report for the selected Market—Property Type.
The report is obtained from a defined GIS report template that uses the currently selected search as its input.
Clicking on the link will open the report in the current browser window.

E. Business Analysis

Special Reports and Analysis will provide a business analysis of the selected property type within the current MSA collateral type.
The system will display the headlines of the last three REIS cast articles and market analysis from the vendor that are related to the MSA and property type the user is currently viewing
The analysis headlines will be displayed as hyperlinks. Clicking on the hyperlink will display the full market analysis in the current browser window.
A More button or similar navigational feature at the bottom of this module will allow the user to view additional analysis headlines

F. Current Real Estate News

Current Real Estate News is a listing of real estate news related to the Market and Property Type that the user is currently viewing.
The system will display the headlines of the last five real estate news articles from the vendor that are related to the MSA and property type the user is currently viewing (previously defined in his/her Property Search). If there are no articles for the MSA, the system will display that last 5 articles.
The news articles headlines will be displayed as hyperlinks. Clicking on the hyperlink will display the real estate article in the current browser window.
A More button or similar navigational feature at the bottom of this module will allow the user to view additional article headlines.

G. Services

Services provide static links to outside business services that may be of interest to those in the real estate profession.
The system will offer links to the following services:
   Survey
   Title
   Permits
   Construction
When the user clicks on a services link, a separate browser window/instance will open. The navigational features (Back/Forward buttons, etc.) and the URL address window will be disabled.
The system will link to an outside search capability such as a yellow pages directory. The outside search fields will be populated through the URL or other such mechanism, and based upon on the Services link the user selected, as well as the MSA and Property Type the user is currently viewing.

H. Submarket

Submarkets is a listing of the submarkets in the selected MSA.
The system will display any submarkets that are part of the active MSA.
If there are no submarkets in the MSA, the Submarkets module will not be displayed.
A Map Submarkets button displays a map of the MSA with the listed submarkets broken out and visually identified. This map will open in a separate Java pop-up window.
The vendor will provide a look-up table with the submarkets defined for each MSA. The system will store the table on-site.
The vendor will also provide the map layers (cartographic files) of the submarkets in every MSA they cover. The specifications (file type, resolution, size, etc.) for these maps will be determined at a later date.
   Research Market—MSA Economics (116)

The following sections will be retrieved on the Market Economics page when it is generated:
Economic Summary
Recent Performance
Industry Structure
Outlook for Real Estate Report
Outlook for Economy Report
Construction Cost Data
Demographics
MSA Strengths/Weaknesses
Leading Industries
Metro Performance
Current Real Estate News
Services

The naming convention for this page is MSA Economics. Each section on the page will include a hyperlinked logo to the website of that data source vendor. Clicking on the logo will open a new browser window/instance that opens the sponsoring vendor's web page. By default, no browser navigation (Back/forward buttons, etc.) or URL Address fields will be displayed on the new browser instance.

A. Economic Summary

Economic Summary is a graphic summary of the economic forces within the MSA. The data source vendor will provide raw numerical data by market on a monthly basis. A static gif will present the data graphically in a bar chart.

B. Recent Performance

Recent Performance is a tabular summary of the economic forces within the MSA.
The data source vendor will provide raw numerical data by market on a monthly basis.
The raw data will be displayed in a table and will include population, retail sales, manufacturing output, employment data, and median house price.
A See Sample button will be provided at the bottom of the module. The user can click on this button to view a sample report prior to purchasing a real one.
An Order Subscription button and an Order Report button will be provided at the bottom of the module to enable the user to order a subscription or to purchase the precis report for the MSA. The user will then access the Purchase Reports function as defined in the E-commerce section of the Back-End Processing Requirements document.

C. Industry Structure

Industry Structure is a tabular summary of the industry structure rankings for the selected MSA relative to the U.S. The data source vendor will provide rankings data by market on a monthly basis. The rankings will be displayed in a table and will include cost of business, cost of living, diversity of industry, and high tech employment.

D. Outlook for Real Estate

Outlook for Real Estate Report is a discussion of the real estate outlook in the selected MSA. Information is provided in a text paragraph and is updated monthly by the vendor.

E. Outlook for Economy

Outlook for Economy Report is a discussion of the economic outlook for the selected MSA. Information is provided in a text paragraph and is updated and replaced monthly by the vendor.

F. Construction Cost Data

Construction Cost Data is a graphic and tabular display of the MSA's labor, material, and total costs for the past four years.
The data source vendor will provide quarterly labor, material and total cost indices at the zip code level for each of the 4 property types (retail, multi-family, office and industrial).
A geographic look-up table will programmatically map zip codes to MSAs.
Data from all the Zip codes in the MSA should be averaged to arrive at the value for that MSA.
A static gif will display the labor, material, and total cost indices for the last four years in a line chart.
The labor, material and total cost data for the last four years will be presented in a table in the following manner:
   1. Data for the most recent quarter should be displayed along with data from the same quarter for the prior 3 years.
   2. Labor cost indices displayed individually.
   3. Material cost indices displayed individually.
   4. Total cost indices.

G. Demographics

Demographics provide a link to a full Demographic Report for the selected MSA. The report is obtained from a defined GIS report template that uses the currently selected search as its input. Clicking on the link will open the report in the current browser window.

H. MSA Strengths/Weaknesses

MSA Strengths/Weaknesses is a list of the economic strengths/weaknesses of the selected MSA. Information is provided in a bulleted list, the number of which will change from month-to-month. Information will be updated and replaced monthly by the vendor. Size of the MSA display box is dynamic and will change automatically based on number of bullets.

I. Leading Industries

Leading Industries consists of two sections:
A graphic representation of the leading industries in the selected MSA.
   The data source vendor will provide raw numerical data on a monthly basis.
   A static gif will display the data and present in a pie chart format.
A tabular representation of Industry Data:
   A listing of the major industries of the MSA and the approximate number of employees/workers in those industries.
   Information is provided in a bulleted list, the number of which will change from month-to-month and market-to-market.
   Information will be updated and replaced monthly by the vendor.
   Size of the Major Industries display box is dynamic and will change automatically based on number of bullets.

J. Metro Performance

Metro Performance is a tabular ranking of the MSA against other MSAs in the country for specific categories by quintile. The data source vendor will provide raw data a monthly basis. The raw data will be displayed in a table. The MSA will be ranked on the following categories:
Population Growth
Net Migration
Employment Growth
Unemployment Rate
Median Household Income

The MSA is ranked according to its placement in the following quintile ranges:
Best (top 20%)
Above Average (21% to 40%)
Average (41% to 60%)
Below Average (61% to 80%)
Worst (81% or below)

Rankings definitions will be shown in color-coded form, with Red representing worst, and Green representing best (and variations in between).

K. Current Real Estate News

Current Real Estate News is a listing of real estate news related to the MSA that the user is currently viewing. The system will display the headlines of the last five real estate news articles from the vendor that are related to the MSA page the user is currently viewing (previously defined in his/her Property Search). If there are no articles for the MSA, the system will display that last 5 articles. The news articles headlines will be displayed as hyperlinks. Clicking on the hyperlink will display the real estate article in the same browser window.

A More button or similar navigational feature at the bottom of this module will allow the user to view additional article headlines. Articles are archived and searchable based on the functional requirements documented in the NewsRoom section below (Note: These functions are implemented in the Search Real Estate News section).

L. Services

Services provide static links to potential outside business services that may be of interest to those in the real estate profession. The system will offer links to the following services:
Survey
Title
Permits
Construction

When the user clicks on a services link, a separate browser window/instance will open. The navigational features (Back/Forward buttons, etc.) and the URL address window will be disabled. The system will link to an outside search capability such as a yellow pages directory. The outside search fields will be populated through the URL or other such mechanism, and based upon the Services link the user selected and the geographical area (MSA) the user is currently viewing.

Research Market—Services and Tools (118)

Services and Tools provides links to related services and business tools the user may be interested in for the property/market currently being displayed. Links to the following pages/sections will be provided:
Appraisal Report
Engineering Report
Environmental Report
Valuation Models
Apply for a Loan

Other links may be generated by the system based on the Research Market search performed and as described by the business rules provided by the system. Clicking on the link will open the appropriate Service or Tool page. All address and other identifying information already entered by the user as part of the Research Market search will automatically populate the corresponding fields in the Service or Tool page, thereby eliminating the need to re-enter the same data.

Obtain Credit Reports (200) (FIG. 3c)

The user will access the Credit Reports section by clicking on the Obtain credit report navigation link in the Research Center. The user will have the ability to search the Credit Reports in any one of 2 areas):
Company Search
Individual Credit Search

Users will have to be registered customers to access the Credit Reports pages (202). If a registered user has previously selected the Log-In Automatically parameter, the system will use a cookie or some other recognition methodology and automatically allow the user into the system. If a registered user has not previously selected the Log-In Automatically parameter, the system will display the Log-In Now/Register option 204. The user can then select Log-In Now and enter his or her User ID and password to access the Credit Reports page. If an unregistered user tries to access the Credit Reports page, the system will display the Log-In Now/Register option 204. The user can then select the Register option. Once registration is completed, the user can then access the Credit Reports page.

In an exemplary embodiment, users must be registered ChoicePoint users in order to purchase Individual Credit Reports. There is a 3 day approval process associated with the ChoicePoint subscription process. (206, 208) When a user registers with the system, he should be given the opportunity to subscribe to ChoicePoint. The user should be notified that there is a 3 day approval process, and until a user is approved, he may not request any Individual Credit Reports. Users who request a report will be charged a flat fee per report.

Referring to FIG. 3c, block 200 is the Home Page for Obtain Credit Reports and allows the user to select the type of Credit Report desired. The user may select either “Individual” or “Company.” After a selection has been made, the user can click on the Go button at the bottom of the page to begin the Credit Report Request process.

A. Obtain Credit Reports—Search Screen

This page will be presented to the user after “Company” has been selected on the Credit Reports Home Page. To conduct a company search, the user will enter information into the following fields on the Company Search form.
Company Name
Street Address
City
State
Zip Code
Company Type

Company Name is a user entered text field referring to the name of the company. Company Name field is required and will be visibly identified as such. Allowable values are any alphanumeric or extended ASCII character.

Street Address is a user entered text field referring to the address of the company. Street Address field is optional. Allowable values are any alphanumeric or extended ASCII character.

City is a user entered text field referring to the city of the company. City field is required and will be visibly identified as such. Allowable values are any alphanumeric or extended ASCII character.

State is a pull-down field referring to the state of the company. Values are obtained from a pull-down list maintained by the system. This field is required and will be visibly identified as such.

Zip Code is a user-entered field for entering the zip code for the system to search on. Allowable values are any integer from 0 to 9. Maximum field length is 9 characters. The system can search on any number of characters 3 or greater. This field is optional.

Company Type is a user-entered selected radio button for entering whether the company is a public or private entity. Selection of the Company Type drives the business logic for how searches are performed on the vendor sites, as well as which pages are retrieved and displayed as the default page on the system.

Selectable values include:

Public

Private

Not Sure

The Company Type field is required and will be visibly identified as such.

Once all required fields are entered, the user can click on the Search button at the bottom of the page to begin the search.

B. Obtain Credit Reports—Public Company

If the user selected Public as the Company Type, the following will occur:
The system will send the request to the NewsAlert website 216, 218, 220. If an exact match is found, NewsAlert will serve up a cobranded page with the public Company Information page displayed as the default.
If an exact match is not found, a page will be returned from NewsAlert with the closest matched hyperlinks. The user can then select a link to display that page.
The page will display a Company Information (active) and Credit Data tab on the right side of the screen. Only the Company Information page will be automatically generated at this point.
If the user clicks on the Credit Data tab, the system will send a credit request in real-time to the D&B website. If an exact match is found, D&B site will then serve up data from the Quick Check data packet which will be formatted and displayed on the site.
If a match is not found, a custom page will be returned on the D&B Site with the closest matched hyperlinks.

C. Obtain Credit Reports—Private Company

If the user selected Private as the Company Type, the following will occur:
The system will send the requested text to the D&B website. If an exact match is found, D&B site will serve up data from the Quick Check data packet to be formatted and displayed on the site.
If a match is not found, a custom page will be returned on the D&B Site with the closest matched hyperlinks.
The end user will choose the correct company and the data will be served up for the system to reformat and display on our site.
The page will display a Credit Data tab only on the right side of the screen, as no additional private Company Information is available from the vendor.
The page will also provide additional links for the target customer to purchase a full Business Information Report or a custom “Decision Support” report from D&B.

D. Obtain Credit Reports—Not Sure

If the user selected Not Sure as the Company Type, the following will occur:
The system will send the requested text to the D&B website. If an exact match is found, D&B site will serve up data from the Quick Check data packet to be formatted and displayed on the site.
If a match is not found, a custom page will be returned on the D&B Site with the closest matched hyperlinks.
The end user will choose the correct company and the data will be served up for the system to reformat and display on our site.
The page will display a Credit Data (active) and Company Information tab on the right side of the screen. Only the Credit Data page will be automatically generated at this point.
If the user clicks on the Company Information tab, the system will send a company information request in real-time to NewsAlert, based on the information the user keyed in on the search criteria page.
   If an exact match is found, this indicates the company is public. NewsAlert will display a cobranded site with the appropriate Company Information displayed.
   If multiple potential matches are found, this indicates the company is probably a public company. A page will then be returned from NewsAlert with the closest matched hyperlinks. The user can then select a link to display that page.
   If NO match is found, this indicates the company is private and no company information is available from NewsAlert. An error message will then be displayed indicating this.

E. Obtain Credit Reports—Purchase Reports

The user can purchase a full Business Information Report or a custom “Decision Support” report from D&B from any company's Credit Data page by clicking on the appropriate button at the bottom of the page. (240,242)
The user will enter purchase information directly on the site. Payments for report purchases will be processed and collected on the site, with the vendor's share being provided to them on a monthly basis.
The system will pull the proper data packets from D&B from the vendor site and deliver to our customers directly.
A See Report Sample button will be provided at the bottom of the top section/module on the page and in the left navigation area. Users can click on this button to view a sample report prior to purchasing a real one (238).
A Purchase Report button will be provided at the bottom of the top section/module on the page and in the left navigation area. Users can click on this button to purchase the Business Information Report or Decision Support Report. The user will then access the Purchase Reports function as defined in the E-Commerce section of the Back-End Processing Requirements document (238).

F. Obtain Credit Reports—Individual

The User begins the request for an Individual Credit Report by Selecting the “Individual” option from the Credit Reports Home Page. (212) There will be 2 separate “online” processes between the system and ChoicePoint.
User Online Subscription
Individual Credit Request
   For both of these processes, the system will link the user to the ChoicePoint cobranded site where the user will interact directly with ChoicePoint.

There will be the following “offline” (i.e., backend) processes between the system and ChoicePoint:
ChoicePoint will notify the system of the user login approvals, ids, passwords, and any changes to user login information. The system will then update the database with the user login information accordingly.
ChoicePoint will provide a daily transaction log to the system containing details on every report purchased by each user. The system will process this information upon receipt and bill each User's credit cards for the reports purchased.

G. Obtain Credit Reports—Subscribing for Individual Reports

The user should be notified that there is a 3 day approval process and until a user is approved he may not request any Individual Credit Reports. The user should be presented with a summary of the agreement with ChoicePoint that he will be required to sign, highlighting the key points. The user should be given the option to continue with ChoicePoint subscription or cancel the process (if, for example, the legalities bother him). If the user decides to subscribe to ChoicePoint, a new pop-up browser window should be opened connecting him directly to ChoicePoint for the Online Subscription Process.

H. Obtain Credit Reports—Individual Report Request

The User begins the request for an Individual Credit Report by Selecting the “Individual” option from the Credit Reports Home Page 212. In order to obtain access to the ChoicePoint system, the user must have a ChoicePoint login. If the user does not have a ChoicePoint login and the database shows that the user has previously subscribed to ChoicePoint and has been denied access, the user should be notified that approval has been denied and he cannot obtain Individual Credit Reports at this time. The user should be redirected to the Credit Reports Home Page. (212)

If user does not yet have a ChoicePoint login, he should be presented with a screen indicating that he must subscribe to ChoicePoint before obtaining an Individual Credit report and asking him if he has already subscribed. If the user responds that he's already subscribed, a window should be displayed indicating that the approval process takes about 3 days and has not yet completed. The user should then be redirected to the Credit Reports Home Page. If the user responds that he has not yet subscribed, he should be redirected to the processing described above under Obtain Credit Reports—Subscribing for Individual Reports to subscribe to ChoicePoint. If user has a ChoicePoint login, continue with the processing below.

The user should be provided with the option to see a sample report. The user should be notified that once he's connected to ChoicePoint, for each credit report he views, he will be charged a fixed fee. He will not be notified as he brings up each report that there is a charge for it. The user should be asked if he'd like to continue with the purchase reports process.

The user will enter purchase information directly on the system site as defined in the E-commerce section of the Back End Functional Requirements with the following clarification/exception: The system may not bill the user at this time, but must wait until the daily transaction log is received from ChoicePoint and processed by the system. The daily transaction log will contain details on all reports purchased by users that day.

The system will redirect the user to ChoicePoint's site and load the requested page in a cobranded arrangement. The system will pass to ChoicePoint the user's login information and a return url. Once the user is on ChoicePoint's site, he can purchase multiple reports, or opt to purchase none. The user purchases a report by viewing it. He will not be notified each time he views a report that the viewing results in a charge.

News and Analysis—Home (300) (FIG. 3e)

A. Accessing the News and Analysis—Home Page

The user will access the News and Analysis section by clicking on the News and Analysis navigation link 300 in the Research Center, through a link on MyWorkSpace or from any other location on the site that links to the News and Analysis Home Page. Once the user accesses the News and Analysis Home Page, he or she may perform the following functions:
Access Real Estate News in MyWorkSpace through the ‘My News’ tab. (304)
View Real Estate News through the ‘News’ tab. (308)
View Top Stories through the ‘Top Stories’ tab (310), including, for example, headlines from:
   CNBC Financial News
   IPG Direct.com Real Estate News
   NewsAlert Data
View Special Reports and Analysis, through the ‘Special Reports and Analysis’ tab. (302)
Search the Archive for real estate related stories and topics through the ‘Search’ tab. (306)

B. Access My Real Estate News in MyWorkSpace (304)

Registered users may click on a link from the News and Analysis home page 300 (or another location) to view their customized news section in MyWorkSpace (304). Users may create up to 5 customized buckets to automatically search for and display real estate news articles. These buckets may be any combination of the following categories:
Company is a user-entered text field for entering a company to the real estate news database to search for.
Market is a pull-down of the MSAs currently identified and maintained by the system.
Property Type is a pull-down of the 5 property/collateral types (Industrial, Multi-Family, Office, Retail, Other) predefined and maintained by the system.
Topic is a pull-down list of categories assigned to the articles. This table is provided and maintained by the vendor.

The system will display the headlines of the last five real estate news articles from the vendor that meet the user's interest profile. News articles headlines will be displayed as hyperlinks. Clicking on the hyperlink will display the entire real estate article in the current browser window using a standard news template developed specifically for GE Capital. A See More button or similar navigational feature at the bottom of the module will allow the user to view additional real estate article headlines.

C. Real Estate News (308)

The Real Estate News Home page 308 will display categories of news with approximately five headlines under each category. The categories to display are tentatively:
Office News
Real Estate Technology
Northeast Regional News

The user will be able to select a headline and get the full text of the article stored in the local database from real-time data feeds. The user will also be able to select the ‘Search News’ tab 334 which will send them to the News and Analysis—Search (306) function where they will be able to enter Keyword search criteria.

D. News and Analysis—Top Stories—Home (A3.2)

The News and Analysis Top Stories Page will include the following 3 modules:
General News
Financial News
Real Estate News

1. General News

The NewsAlert News section is a listing of current general news that may be of interest to users of the system. The system will display the headlines of the last five general news articles from the vendor. The most recent headlines will be obtained by a real time API to the NewsAlert naserver and will bring back the headlines to the site. The news articles headlines will be displayed as hyperlinks. Clicking on the hyperlink will display the full content of the news article in a new browser window/instance that launches the appropriate web page on the vendor's website. By default, no browser navigation (Back/Forward buttons, etc.) or URL Address fields will be displayed on the new browser instance.

A More button or similar navigational feature at the bottom of this module will allow the user to view additional article headlines. This will launch the vendor's web page (in a separate browser window as described above) with a complete listing of news headlines. In an exemplary embodiment, articles will not be archived and are therefore not searchable on the site, but end users will have the ability to search the news archives on Newsalert's site.

2. Financial News

The Financial News section is a listing of current financial news that may be of interest to users of the system. The system will display the headlines of the last five finanicial news articles from the vendor. The vendor will funish a live feed that will automatically update this news articles list throughout the day. The financial news articles headlines will be displayed as hyperlinks. Clicking on the hyperlink will display the full content of the news article in a new browser window/instance that launches the appropriate web page on the vendor's website. By default, no browser navigation (Back/Forward buttons, etc.) or URL Address fields will be displayed on the new browser instance.

A More button or similar navigational feature at the bottom of this module will allow the user to view additional article headlines. This will launch the vendor's web page (in a separate browser window as described above) with a complete listing of financial news headlines. In an exemplary embodiment, articles will not be archived and are therefore not searchable.

3. Real Estate News

The system will display the headlines of the last five real estate news articles from the vendor. The vendor will provide a feed that automatically downloads the real estate news articles list and content periodically (via FTP or other such mechanism). The system will store and archive the news articles in the system database for a predefined period of time, e.g., one year from the date they are received. Articles are archived and searchable based on the functional requirements documented in the Searching the Archive section below. The news articles headlines will be displayed as hyperlinks. Clicking on the hyperlink will display the real estate article in the current browser window.

A More button or similar navigational feature at the bottom of this module will allow the user to view additional real estate article headlines.

E. Special Reports & Analysis (302)

Special Reports and Analysis is comprised of feature articles and content that provides more in-depth information about specific real estate subjects. The page will display three categories of articles with 5 reports under each category. The initial categories are:
REIS Casts
Market Report
Association Newsletters

The vendor will provide a feed that automatically downloads the feature content periodically (via FTP or other such mechanism). The system will store and archive the feature content in the system database for one year from the date it is received. Features are archived and searchable based on the functional requirements documented in the Searching the Archive section below. The system should be flexible enough to allow for searches based on keyword or categories.

F. Search (306)

The Search feature allows the user to search for real estate related news as well as general news content. The search will be a keyword search entered by the user. The user will have the option to search either real estate news or general news via a button option. The system will assume that multiple distinct words or character strings in a single text entry search field are linked together by the OR Boolean operator.

If real estate news is desired, the local database of IPG stored news stories will searched with resulting headline matches and selected articles displayed. If general news is desired an API will be invoked which will search the NewsAlert database with resulting headline matches and selected articles displayed utilizing the NewsAlert Cobranded site.

An advanced search function 324 may also be provided. The advanced search feature 324 allows the user to search the system database for real estate related news and feature content. The search will be limited to real estate news and feature content stored on the site. Users cannot search the archive for general or financial news. This is a business rule defined by our contracts with the vendors However, the search mechanism will be flexible enough to enable searches based on additional categories if that may be added in the future.

The search mechanism will allow users to enter any of the following search criteria:
Subject
Market
Property Type
Published Date

Users must enter information into at least one search field. If a user does not enter sufficient information, the system will display an error message indicating that more information is required before the search can proceed.

Subject is a pull down list that will correspond to the coded subject field from IPG. The user can select multiple subjects for one search. If the user wants a blank/null field, he or she may use the Backspace or Delete key to clear any previously entered entry.

Market is a pull-down list of all available MSAs that can be searched on.
The list of MSAs to search on will be limited to the MSAs that the IPG database supports.
The user can position on an area of the list by typing in an alphabetic character in the search field and then be placed on the first occurrence of that letter in the pull down list.
If the user wants a blank/null field, he or she may type a space to clear any previously selected entry.

Property Type is a user-selected field for entering the property collateral type for the system to search on.
Values are obtained from a pull-down list maintained by the system.
The drop-down choices will be based on the categories provided by the news vendor
If the user wants a blank/null field, he or she may type a space to clear any previously selected entry.

Publication Date allows the user to filter the results by publication date.
The publication date is defined as follows:
   If the item is a news article, the publication date occurs when the vendor originally published the article.
   If the item is not a news article, the publication date occurs when the content was originally loaded and archived into the system.
The date filter values are obtained from a pull-down list maintained by the system.
In an exemplary embodiment, the system will be limited to the following date filters:
   Last 24 Hours
   Last Week
   Last Month
   Last Year
If the user wants a blank/null field, he or she may type a space to clear any previously selected entry.

The user can submit the search to the system, change/clear the search criteria and re-enter them, or leave the search area entirely. The following defaults will be assumed by the system during a search:
Any search field where a parameter has neither been selected nor entered has (by definition) a null value. The system will not consider or use null values during a search.
The system will assume that multiple distinct words or character strings in a single text entry search field are linked together by the OR Boolean operator.
The system will assume that any search fields where a parameter has been selected or entered (and are therefore not null) are linked together by the AND Boolean operator.

By default, a maximum of 15 articles will be displayed per page. If there are more retrieved results than the selected display number, the system will create additional pages as required with an appropriate navigation schema (such as with Previous/Next buttons) so the user may move easily between pages.

The system will present the user with a list of potential matches that meet the search parameters selected by the user. These matches will be retrieved as hyperlinks on a Search Results page, and ordered as determined by the following Relevancy/Display Order business rules (330):
If the search term or terms are in the headline, it is given top priority and displayed in the first grouping on the Search Results page.
If the search term or terms are in found only in the article, it will be displayed in the second grouping on the Search Results page.

Articles/features within groups are displayed in reverse chronological order, with the most recent article first. Clicking on a hyperlink will display the entire content of the news article/feature in the current browser window (330). News articles will be clearly identified as News and will include the date the article was published.

Order Available Reports—Home (400) (FIG. 3f)

A. General Requirements

The system includes e-commerce functionality to enable users to purchase market reports as well as other products and services. Use of the e-commerce feature set is restricted to registered users who enter credit card information for payments. To use the e-commerce features, users must access the web site using a web browser with 128-bit encryption enabled.

In one exemplary embodiment, only individual or ad hoc purchases of products and services will be allowed. Additional purchase options, such as subscription services and charges per transaction, may be implemented in other embodiments. The design purchasing features should be reusable and extensible so that future upgrades do not require re-architecting and extensive reprogramming.

The system can process purchases in one of two ways. These options are payments collected by the system and payments collected directly by the vendor. In some situations, the user will access the vendor's site directly to complete his or her purchase. In these cases, the following basic requirements will be met:
User will access the vendor site through a link within the system.
Purchases made through vendor site are not managed by the system. Registration and credit card information from the system will not be transferred to vendor.
Validation of user purchases at partner vendor websites will not be systematically validated by the system.

Users can purchase various products and services (such as market reports) from the site where that product or service is discussed on the site. This context-sensitivity is a key feature of the system and will apply to all products and services offered throughout the site. In some cases (such as for reports), the user may view a sample before making the actual purchase. Users can view a sample by clicking the See Sample button 406 provided in the left navigation area or other intuitive location on the page. A sample report with canned data will appear in HTML format in a separate browser instance.

To select a full report (or other product) for purchase, the user will click on the Purchase <Item> button on the web page where that product/report is discussed. This button will be provided in the left navigation area or other easily accessible location on the page.

Quick Feature Overview (500) (FIG. 3g)

The system will include a Quick Feature Overview 500 that describes the functionality of the Research Center and its modules to the user in an easy to understand and intuitive format. Users will access the Quick Feature Overview 500 by clicking on the appropriate button or tab on the web site. The Quick Feature Overview will be developed in HTML, Flash or other similar widely available industry-standard technology to provide optimal impact and usability.

Additional Features

Print Page (122, FIG. 3b)

Users will have the ability to print a printer-friendly version of any research page that is hosted on the site. Clicking on the printer-friendly navigation item will load the existing page viewed on the end user's screen into a specially formatted template which will contain the same viewable content but organized to print with clean page breaks on a standard page formatted page. The Property Name field will be included in printable versions of research pages, and will add to the professional look and feel of those printed reports. This information will be displayed in the upper right hand corner along with other user-inputs (i.e. Address, City, State) Users will have to click the Print button on the browser program to execute the print.

Print Package (124, FIG. 3b)

Users will have the ability to print a printer-friendly version of any research page that is hosted on the site. Clicking on the printer-friendly navigation item will load the existing page viewed on the end user's screen into a specially formatted template which will contain the same viewable content but organized to print with clean page breaks on a standard page formatted page. The Property Name field will be included in printable versions of research pages, and will add to the professional look and feel of those printed reports. This information will be displayed in the upper right hand corner along with other user-inputs (i.e. Address, City, State) Users will have to click the Print button on the browser program to execute the print. The Print Package will print the Property Level demographics page, the Submarket Page, the MSA Real Estate page and the MSA Economics page. The actual number of pages will depend on the property search.

Save to MyWorkSpace (128, FIG. 3b)

Users will have the ability to save any property search results that an end user executes. This information will be organized in the Real Estate activity area of MyWorkSpace. Documentation for the organization of this content can be found in the MyWorkSpace section. Users must be registered users to save a property to their workspace. Unregistered users will be prompted to register before being able to save a property search result to the workspace

Users will have access to save a property search by clicking on the save button or similar navigational item located on any result page of the property search. Users who choose to save a property will be redirected to a verification page that displays the property fields originally entered by the user. The end user will additionally have the option to save a property name with the research request to reference the research request later. End users will have the ability to save the request or cancel the save request from this page.

Property Name is a user-entered field for entering the name of the user's company. Allowable values are any alphanumeric or extended ASCII character. This field is optional.

The user will be redirected to their MyWorkSpace site after executing the save function with the saved property displayed in the My Real Estate Activities section.

The system will only save the property input details along with pointers (calculated GIS market codes) to the pages it retrieved in the package. The system will not store the html pages themselves in the workspace, because the content is dynamic and static html pages quickly become outdated. The fields below demonstrate the fields that will be saved with each property package saved:
Property Name (Optional)
Property Address
Property City
Property State
Property Zip Code
Property Latitude (Calculated by GIS)
Property Longitude (Calculated by GIS)
Property Market Code (Calculated by. GIS)
Property Submarket Code (Calculated by GIS)
Property Market Property Type

FIGS. 4a-4i are representative display screens for a Web site supporting the online research center tool in accordance with an exemplary embodiment of the present invention.

1. An on-line real estate information aggregation system, comprising:
a distributed computer network;
a plurality of client computers, coupled to said distributed computer network, comprising at least one of the client computers, each operated by a call center agent, to provide telephone call support for a real estate-related transaction comprising a leasing, financing, or buy-sell transaction, and at least one other client computer operated by a real estate transaction individual in support of said real estate transaction;
a property services server platform, coupled to said distributed computer network, responsive to a communication transmitted by said at least one other client computer to support said real estate transaction by processing said communication and real estate data maintained by at least one remote data source coupled to the distributed computing network, the property services platform comprising:
a real estate information processing tool hosted on said property services server platform for processing financial information related to said real estate transaction;
a research market module hosted on said property services server platform for accessing research information on available properties and markets related to said real estate transaction, compiling said research information into summaries and conducting business analyses on said available properties and markets;
a credit reports module hosted on said property services server platform for accessing credit report information of individuals and companies related to said real estate transaction;
a news and analysis module hosted on said property services server platform for accessing real estate news information related to said real estate transaction; and
an order available reports module hosted on said property services server platform for enabling a market report purchase related to said real estate transaction.

2. The on-line real estate information aggregation system of claim 1, further comprising a call center, coupled to the distributed computer network and a telephony network, comprising a plurality of call center agents, wherein:
said call center assigns at least one of said call center agents to support said real estate transaction based on relevant real estate experience; and
said research market module includes links to related services and business tools.

3. The on-line real estate information aggregation system of claim 2, wherein:
said related services and business tools comprise at least one of appraisal services, engineering services, surveying services, permit services, title services, and construction services;
one of said call center agents is a customer service agent; and
another one of said call center agents is a deal agent.

4. The on-line real estate information aggregation system of claim 1, wherein:
said research market module is operative to:
receive search criteria for a desired property or market from a one of the other client computers;
compare the received search criteria with research information stored in said data source; and
if the received search criteria matches the stored research information, providing the stored research information to the other client computer; and
said real estate information processing tool is further operative to calculate a real estate payback in connection with said real estate transaction and to send said calculated real estate payback to said other client computer.

5. The on-line real estate information aggregation system of claim 1, wherein
said news and analysis module is operative to:
receive search criteria for a desired category of news from a one of the other client computers;
compare the received search criteria with real estate news information stored in said data source; and
if the received search criteria matches the stored real estate news information, provide the stored real estate news information to the other client computer and
said a real estate information processing tool is further operative to:
receive actual and projected revenue and expenses of a real estate property for said real estate transaction from the other client computer via said distributed computer network; and
return a valuation of said real estate property to the other client computer based on said actual and projected revenue and expenses.

6. A method for aggregating real estate information content for use in a distributed computing environment, said method comprising the steps of:
providing at a server platform, accessible via the distributed computing environment, a research market module for accessing research information on available properties and markets;
providing at the server platform a credit reports module for accessing credit report information of individuals and companies;
providing at the server platform a news and analysis module for accessing real estate news information;
providing at the server platform an order available reports module for purchasing market reports; and
providing at the server platform a real estate information processing tool operative to receive financial information for a real estate transaction, generate derived financial information in response to processing said financial information based on a communication received from one of a plurality of computers coupled to the distributed computing environment, and transmit the derived financial information to the computer via the distributed computing environment.

7. The method of claim 6, wherein:
said research market module includes links to related services and business tools;
the derived financial information comprises a valuation of real estate associated with the real estate transaction; and
the step of transmitting the derived financial information comprises transmitting the valuation of the real estate over the distributed computing environment to a lender operating one of the computers in the distributed computing environment.

8. The method of claim 7, wherein:
said related services and business tools comprise at least one of appraisal services, engineering services, surveying services, permit services, title services, and construction services; and
the real estate information processing tool receives financial information by receiving projected revenue and expenses of the real estate from one of the computers in the distributed computing environment.

9. The method of claim 6, further comprising the step of providing a call center, comprising an agent staff, for providing real estate customer services via telephony communications,
wherein said research market module is operative to:
receive search criteria for a desired property or market;
compare the received search criteria with the available research information; and
if the received search criteria matches the available research information, provide the research information to the user.

10. The method of claim 6, wherein said news and analysis module is operative to:
receive search criteria for a desired category of news;
compare the received search criteria with the available real estate news information; and
if the received search criteria matches the available real estate news information, provide the real estate news information to a user operating one of the computers in the distributed computer environment, and wherein
the derived financial information for the real estate transaction comprises at least one of a real estate payback calculation, a real estate improvement calculation, a real estate direct capitalization calculation, a real estate refinancing calculation, and a real estate cash flow calculation.

11. The method of claim 9, wherein the call center assigns at least one agent of the agent staff to support the real estate transaction based on relevant real estate experience.

12. The on-line real estate information aggregation system of claim 4, wherein said real estate information processing tool comprises at least one of a real estate lease improvement calculator, a real estate direct capitalization calculator, and a real estate refinancing calculator.

13. The on-line real estate information aggregation system of claim 1, wherein said real estate information processing tool is for that operative to:
receive a financial projection related to said real estate transaction from one of the other client computers;
generate a real estate valuation based on said financial projection; and
return said real estate valuation to said other client computer.

14. The on-line real estate information aggregation system of claim 13, wherein said other client computer is operated by a seller or a prospective buyer associated with said real estate transaction and said real estate information processing tool is further operative to send said real estate valuation to a lender associated with said real estate transaction.

15. The on-line real estate information aggregation system of claim 1, wherein said real estate information processing tool comprises a real estate lease improvement calculator, operative to: receive a building improvement scenario related to said real estate transaction from one of the other client computers; calculate a profit based on said building improvement scenario; and send said calculated profit to the other client computer.

16. The on-line real estate information aggregation system of claim 15, wherein said real estate lease improvement calculator is further operative to calculate a rent increase based on said building improvement scenario and calculate said profit based on said rent increase.

17. The on-line real estate information aggregation system of claim 1, wherein said real estate information processing tool is operative to calculate a capitalization rate for a real estate property associated with said real estate transaction.

18. The on-line real estate information aggregation system of claim 1, wherein said real estate information processing tool comprises a cash flow calculation tool for calculating cash flow related to said real estate transaction.

19. The on-line real estate information aggregation system of claim 18, wherein said cash flow calculation tool comprises:
a mortgage and amortization calculator, operative to calculate mortgage payments on a real estate loan related to said real estate transaction; and
an affordability calculator, operative to calculate a loan amount based on underwriting criteria and operating income related to said real estate transaction.

20. The on-line real estate information aggregation system of claim 19, wherein said mortgage and amortization calculator is further operative to calculate principal and interest payments for a fixed real estate loan related to said real estate transaction.
